(19) United States
(12) Patent Application Publication
(10) Pub. No.: US 2024/0339801 A1
(43) Pub. Date: Oct. 10, 2024

(54) INTELLIGENT PHASE CONTROL METHOD FOR LASER COHERENT COMBINATION

(71) Applicant: Guangdong University of Technology, Guangzhou (CN)

(72) Inventors: Jianglei DI, Guangzhou (CN); Wenjun JIANG, Guangzhou (CN); Guiyuan TAN, Guangzhou (CN); Junzhe GAO, Guangzhou (CN); Jiazhen DOU, Guangzhou (CN); Liyun ZHONG, Guangzhou (CN); Yuwen QIN, Guangzhou (CN)

(21) Appl. No.: 18/627,224

(22) Filed: Apr. 4, 2024

(30) Foreign Application Priority Data
Apr. 4, 2023 (CN) 202310354103.7
Oct. 7, 2023 (CN) 202311283704.X

(51) Int. Cl. H01S 3/10; G06N 3/045; H01S 3/00; H01S 3/067

(52) U.S. Cl. CPC H01S 3/10053; G06N 3/045; H01S 3/0085; H01S 3/067

(57) ABSTRACT

The present invention discloses an intelligent phase control method for laser coherent combination for solving the difficulties of high hardware requirements of traditional methods, low robustness of phase control methods based on deep learning. The method of the present invention is to repeatedly input the diffraction patterns after coherent combination of beams with random phases into a reinforcement learning system to update the parameters of the network inside according to the actions it performs and the rewards it obtains. After updating, the diffraction pattern is input to the network, the network outputs some values and the action corresponding to the largest value is selected and converted into a correction signal to the phase controllers, which adjusts the phase of the beam by voltage to obtain a high output. The method of the present invention can efficiently realize the phase control of the laser with high robustness and real-time performance.

### FIELD

The present invention relates to the technical field of laser coherent combination, and specifically relates to an intelligent phase control method for laser coherent combination.

### BACKGROUND

Laser is generated by amplification of light from excited radiation. To realize laser generation, there must be two conditions, the generation and amplification of excited radiation, and the device that can realize this function is called a laser device. There are many types of laser device, and one of the more widely used is the fiber laser device. Nowadays, as lasers are being used more and more in medical, military, industrial processing and other fields, the pursuit of the goal has slowly evolved into obtaining high power, high beam quality and high brightness laser output. Although today's diode-pumped laser amplifier technology has matured, but due to the optical component energy threshold, laser heat dissipation and other physical limitations, resulting in a single fiber laser output power is limited, so in order to achieve hundreds of thousands of watts of laser output, we need to use laser coherent combination technology to synthesize the multiple lasers so as to obtain high-power laser output. The phase control technique is the key to realize the coherent combination of multiple lasers.

Generally speaking, the active phase control technology is through the detector to provide remote synthesis spot information, after a variety of different means of processing, the beam phase adjustment, in order to achieve the purpose of multiple units of beam focusing on a specific target surface. Currently, in the fiber laser coherent combination system, the traditional active phase control methods include the heterodyne method, the dither method and the stochastic parallel gradient descent algorithm SPGD, which can all effectively correct the phase of each beam. Among them, the traditional methods like the heterodyne method, the multi-dither method, and the SPGD face some intractable drawbacks: the hardware system requirements are too high, and the control bandwidths all decrease dramatically with the increase of the number of sunbeams. In addition, although deep learning-based phase control methods can quickly compensate the phase difference between beams by a single step of iteration under ideal circumstances, such methods also have more obvious drawbacks: the training of a good phase correction network requires the pre-production of thousands of labels, and although generating the labels in a simulation system is not difficult, the ultimate goal of the research is inevitably to apply them in a real system. At this point, collecting a large amount of labeled data in a real experimental environment will waste a lot of time and resources; in addition, the trained neural network will not fine-tune the parameters according to the environment in which the system is located, so it cannot get the expected coherent combination strength and efficiency when facing unfamiliar environments such as different noise perturbations as well as different atmospheric turbulence. There are also a small number of methods based on reinforcement learning that can correct the phase in a single step, but the training time of the network grows dramatically with the number of sub beams, which makes it difficult to be utilized in practical systems.

### SUMMARY

An object of the present invention is to overcome the deficiencies of the prior art and provide an intelligent phase control method for laser coherent combination, which can quickly realize the coherent combination of multiple lasers, and can solve the problems of high hardware requirements in the traditional method and the long training time of the reinforcement learning-based method, and in which the neural network in the method can quickly converge and at the same time ensure the real-time performance of phase correction in the coherent synthesis system.

The technical solution of the present invention to solve the above problems is: An intelligent phase control method for laser coherent combination, comprising the following steps:
(S1). dividing the output of the infrared laser into M beams using a beam splitter after passing through the optical fiber, then feeding into the corresponding phase modulators to control the phases;
(S2). expanding and collimating the beams after phase modulation of the M beams, and outputting to the focusing lens to focus the M beams;
(S3). passing the focused beam through the polarizer, the microscope objective lens and the semi-transparent and semi-reflective mirror, and transmitting a part of the light to the photodetector CCD to obtain the diffracted image A after the coherent synthesis of the M-beam laser, and reflecting another part of the light to the target to obtain the light intensity value;
(S4). modulating phases by feeding a set of known voltages as the phase control signals to the phase modulators, and then obtaining a phase modulated diffracted image B after passing through the optical system, followed by resetting of the controller; superimposing the diffracted image A and the diffracted image B in the channel dimension and then inputting to the trained Q network, which outputs the Q values corresponding to each action in the action space, taking the action corresponding to the maximum Q value, and outputting phase control signals corresponding to the action to the phase modulator to correct the phase of each laser, so as to realize the output of laser coherent combination with high power.

Preferably, in step (S4), the phase modulation is realized by controlling the phase modulator through the FPGA; the specific implementation is realized by writing a program in the control chip FPGA, so that when it receives an action signal, it first joins the known modulation signals together with the input action signal to the phase modulator, and the CCD collects the intensity map of the coherent combination system after modulation. After the CCD collects the intensity map of the coherent combination system after modulation; FPGA reset, only the action signal being the input of the phase modulator, the CCD gets another intensity map of the coherent combination system, and the control chip stacks the two intensity maps as a state input to the network; wait for the next action input, and repeat the process.

Preferably, in step (S4), the acquisition of the trained Q network comprises the following steps:
(S4-1). building a convolutional neural network Q network whose input is two images stacked in channel dimension and output is a set of Q values corresponding to the action space;
(S4-2). passing M beam through the optical system to obtain a diffraction image, and then feeding a set of known phase to the controller for phase modulation, after passing through the optical system obtaining a modulated diffraction image, resetting the phase modulators; acquiring 2 diffraction image stacked as a state input, and inputting to the Q network, outputting the Q values corresponding to each action in the action space by the network, taking the action corresponding to the maximum Q value, converting the correction action into a phase correction signal and then feeding it back to the phase modulators in the optical system, obtaining a new diffraction pattern, and obtaining the intensity from PD and then performing a computation as a reward obtained from the execution of the action by the Q network;
(S4-3). back-propagating the gradient value of the loss function according to the reward to update the weights and bias parameters of the neural network, outputting again the Q values corresponding to each action in the action space, taking the action corresponding to the maximum Q value, and feeding back to the phase modulators after converting this correction action into a phase correction signal;
(S4-4). randomly generating the phase of M beams when the value of the coherent combination evaluation function is greater than a preset value, repeating steps (S4-2), (S4-3), and (S4-4), updating the neural network parameters several times, and stopping the updating when the Q-network training converges.

Preferably, in step (S4-1), the Q network is constructed from a convolutional layer with a convolutional kernel size of 3*3, a maximal pooling layer, an activation function, and a fully-connected layer; firstly, the two stacked diffraction images are taken as the inputs, and then after three times of a convolutional layer with a convolutional kernel size of 3*3, a maximal pooling layer, and an activation function in sequence, the Q value corresponding to the action space is outputted after inputting it into the 2—layer fully-connected layer.

Preferably, in step (S4-1), said action space is Aₘᵢₙ, with the specific expression:

$${A}_{mn} = {rate}_{1} \cdot [ {a}_{1} , … , {a}_{i} , … , {a}_{m} ] + … + {rate}_{t} \cdot [ {a}_{1} , … , {a}_{i} , … , {a}_{m} ] + … + {rate}_{x} \cdot [ {a}_{1} , … , {a}_{i} , … , {a}_{m} ] \qquad ( 1 )$$

$${a}_{i} = {[ 0 , {e}_{i 1} , … , {e}_{ij} , … , {e}_{i n} ]}^{T} \qquad ( 2 )$$

$${e}_{ij} = \{ \begin{matrix}1 , & i mod {2}^{j} = 1 \\ - 1 , & otherwise\end{matrix} \qquad ( 3 )$$

where rateₜ is the scale of the i^{th} action space, aᵢ is the correction phase, x is the number of mixed action space scales, m equals 2^{M-1}, n equals M−1, M is the number of beams and mod is the modulo operator.

Preferably, in step (S4-2), reward is expressed as follows:

$$Reward = α ( PIB - {PIB}_{old} ) - β ( 0.95 - PIB ) + r \qquad ( 4 )$$

$$r = \{ \begin{matrix}1 & if PIB \geq 0.95 \\ 0 & if PIB < 0.95\end{matrix} \qquad ( 5 )$$

where α and β are adjustable parameters, PIB is the normalized power in the bucket at the current moment, and PIB_{old} is the normalized power in the bucket at the previous moment.

Preferably, in steps (S4-4), said coherent combination evaluation function includes, but is not limited to, the power in the bucket, the highest output power, the main flap power, the quality factor of the synthesized beam, and a combination of the above physical quantities.

Preferably, in steps (S4-4), the loss function of Q-network and the weights and bias parameters of the nerves are updated with the equation:

$${y}_{t} = {r}_{t} + γ {Q}_{π} ( {s}_{t + 1} , {a}_{t + 1} ) \qquad ( 6 )$$

$${{w}_{t + 1} = {w}_{t} - α \cdot \frac{\partial Loss ( {Q}_{π} ( {s}_{t} , {a}_{t} ) , {y}_{t}}{\partial w} \vert}_{w = {w}_{t}} \qquad ( 7 )$$

where rₜ is the reward obtained at the current moment, γ is the discount factor, Q_{π}(sₜ, aₜ) is the output value of the state and action under moment t of the Q network, Q_{π}(sₜ₊₁, aₜ₊₁) is the output value of the state and action under moment t+1 of the Q network, wₜ is the weight and bias parameter of the neuron under moment t of the neural network, and wₜ₊₁ is the weight and bias parameter of the neuron under moment t+1 of the neural network; Loss( ) is a function to measure the difference between two values (for example L1 paradigm or L2 paradigm, etc.), and α is the learning rate.

The present disclosure has the following beneficial effects compared with the prior art:
1. The network structure of the present invention is relatively simple, only the use of neural networks in the more basic convolutional layer, pooling layer and fully connected layer, can be realized. In addition, due to fewer parameters, fast fitting can be realized in the training process to adapt to the laser coherent combination task, and at the same time, in the application process, the neural network can be fast enough to compensate for the changes brought by the noise to the coherent combination system due to the small amount of computation.
2. Compared to existing deep learning methods, when the present invention is deployed in an actual coherent combination system, the neural network in the reinforcement learning method will fine-tune the network parameters according to environmental factors such as atmospheric turbulence, random noise perturbations, etc., and the various environmental factors will be fed back to the neural network in a timely manner, so that the Q network therein can well adapt to the environmental changes, avoiding the problem of difficult adaptation that occurs when the deep learning algorithms are deployed in a real environment.
3. The biggest advantages of the present invention over other reinforcement learning algorithms are short training time, low parameter sensitivity, and high robustness. Since the output correction actions of the present invention are all discrete actions, the network will converge more easily relative to continuous actions, the training time will be reduced by dozens or even hundreds of times, and the parameters that need to be adjusted are fewer than those of a reinforcement learning system based on continuous actions, which makes the reinforcement learning method easier to be deployed in practice on coherent beam combination systems to accomplish the correction of noise.
4. The present invention not only adopts a discrete action distribution in the action of the Q network output, but also adopts a mixed action scale, which refers to different sizes of phase correction actions. If only a single size of phase correction action is adopted, the action is too large to cause the Q network to be unable to correct the coherent combination evaluation function corresponding to the output of the system to the preset maximum value, and it is easy to keep wandering between certain two values. The Q network will not be able to converge if the phase correction action is too large. If the action is too small, the Q network will need to iterate for a very large number of steps to correct the random noise when the random noise is applied to the coherent combination system, and then the noise will continue to change, which will not only lead to slow correction when applied to the actual system, but also lead to the Q network not being able to converge to a more desirable value in the actual training. The present invention adopts a mixed action space to solve the above problem, the Q network will learn the action law during training, the larger action can quickly raise the output of the coherent combination to a larger power in the early stage of correction, the smaller action is responsible for the output of the system can be corrected to a more ideal value of high output at the end of the correction.

### BRIEF DESCRIPTION OF THE DRAWINGS

FIG. 1 shows a system block diagram of an intelligent phase control method for laser coherent combination.

FIG. 2 shows a schematic diagram of the structure of a Q network.

FIG. 3 shows a training convergence diagram of the Q network in an embodiment.

FIG. 4 shows a result of the coherent combination system under the action of the Q network in the embodiment.

### DETAILED DESCRIPTION OF THE EMBODIMENTS

The present invention is described in further detail below in conjunction with the embodiments and the accompanying drawings, but the embodiments of the present invention are not limited thereto.

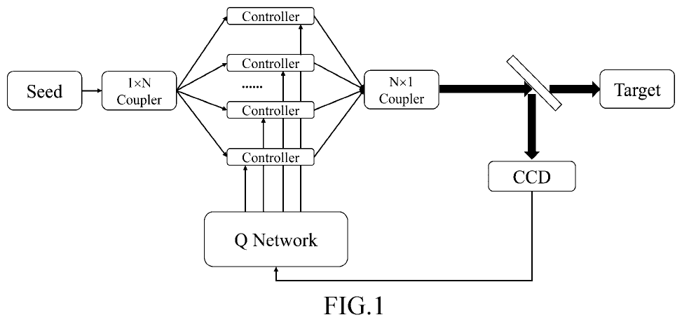

Referring to FIG. 1, an embodiment of an intelligent phase control method for laser coherent combination comprises the following steps:
(S1). dividing the output of the infrared laser into 7 beams using a beam splitter after passing through the optical fiber, then feeding into the corresponding phase modulators to control the phases;
(S2). expanding and collimating the beams after phase modulation of 7 beams, and outputting to the focusing lens to focus the 7 beams;
(S3). passing the focused beam through the polarizer, the microscope objective lens and the semi-transparent and semi-reflective mirror, and transmitting a part of the light to the photodetector CCD to obtain the diffracted image A after the coherent synthesis of the M-beam laser, and reflecting another part of the light to the target to obtain the light intensity value;
(S4). modulating phases by feeding a set of known voltages as the phase control signals to the phase modulators, and then obtaining a phase modulated diffracted image B after passing through the optical system, followed by resetting of the controller; superimposing the diffracted image A and the diffracted image B in the channel dimension and then inputting to the trained Q network, which outputs the Q values corresponding to each action in the action space, taking the action corresponding to the maximum Q value, and outputting phase control signals corresponding to the action to the phase modulator to correct the phase of each laser, so as to realize the output of laser coherent combination with high power.

In step (S4), the phase modulation is realized by controlling the phase modulator through the FPGA; the specific implementation is realized by writing a program in the control chip FPGA, so that when it receives an action signal, it first joins the known modulation signals together with the input action signal to the phase modulator, and the CCD collects the intensity map of the coherent combination system after modulation. After the CCD collects the intensity map of the coherent combination system after modulation; FPGA reset, only the action signal being the input of the phase modulator, the CCD gets another intensity map of the coherent combination system, and the control chip stacks the two intensity maps as a state input to the network; wait for the next action input, and repeat the process.

In step (S4), the acquisition of the trained Q network comprises the following steps:
(S4-1). building a convolutional neural network Q network whose input is two images stacked in channel dimension and output is a set of Q values corresponding to the action space;
(S4-2). passing 7 beams through the optical system to obtain a diffraction image, and then feeding a set of known phase to the controller for phase modulation, after passing through the optical system obtaining a modulated diffraction image, resetting the phase modulators; acquiring 2 diffraction image stacked as a state input, and inputting to the Q network, outputting the Q values corresponding to each action in the action space by the network, taking the action corresponding to the maximum Q value, converting the correction action into a phase correction signal and then feeding it back to the phase modulators in the optical system, obtaining a new diffraction pattern, and obtaining the intensity from PD and then performing a computation as a reward obtained from the execution of the action by the Q network;
(S4-3). back-propagating the gradient value of the loss function according to the reward to update the weights and bias parameters of the neural network, outputting again the Q values corresponding to each action in the action space, taking the action corresponding to the maximum Q value, and feeding back to the phase modulators after converting this correction action into a phase correction signal;
(S4-4). randomly generating the phase of 7 beams when the value of the coherent combination evaluation function is greater than a preset value, repeating steps (S4-2), (S4-3), and (S4-4), updating the neural network parameters several times, and stopping the updating when the Q-network training converges.

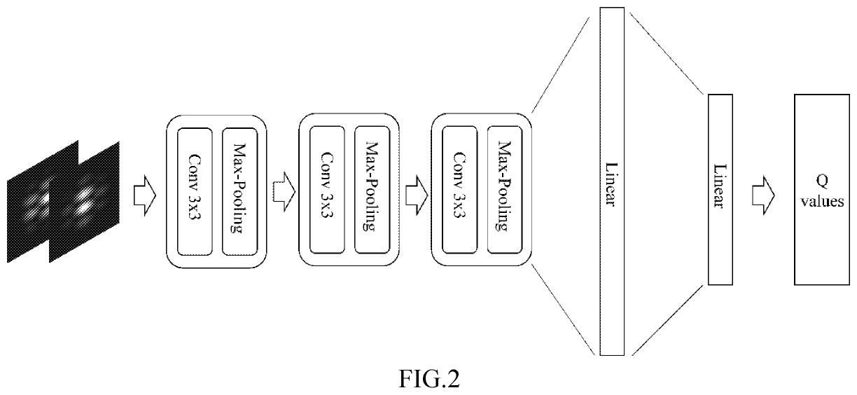

Referring to FIG. 2, in step (S4-1), the Q network is constructed from a convolutional layer with a convolutional kernel size of 3*3, a maximal pooling layer, an activation function, and a fully-connected layer; firstly, the two stacked diffraction images are taken as the inputs, and then after three times of a convolutional layer with a convolutional kernel size of 3*3, a maximal pooling layer, and an activation function in sequence, the Q value corresponding to the action space is outputted after inputting it into the 2—layer fully-connected layer.

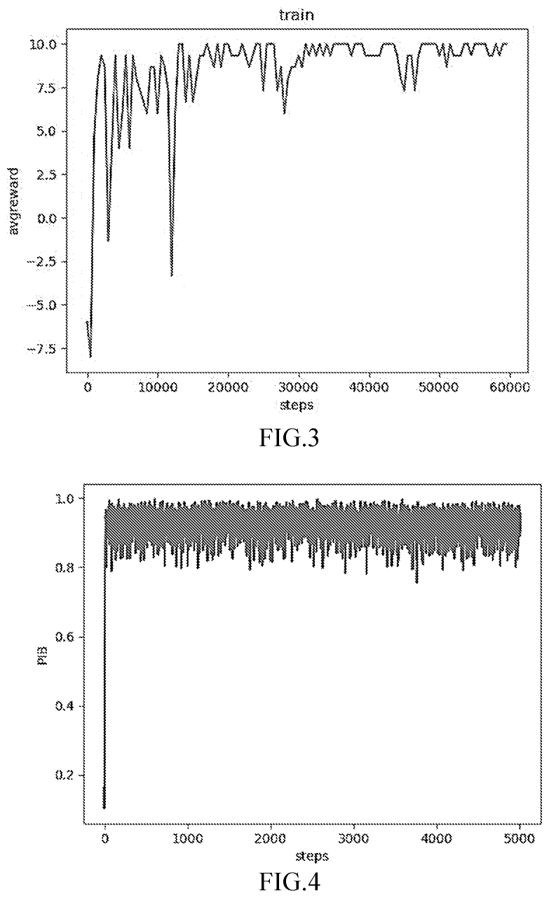

Referring to FIG. 3, with the above setup, fast fitting can be achieved during training to adapt to the laser coherent combination task, and the input is two stacked intensity maps, the method does not use too many convolutional networks to extract the features, and the important information can be fitted by the multi-layer perceptron, which prevents serious overfitting. And the neural network update using the method of reinforcement learning, which makes the trained Q-network more robust.

Additionally, in step (S4-1), said action space is Aₘᵢₙ, with the specific expression:

$${A}_{mn} = {rate}_{1} \cdot [ {a}_{1} , … , {a}_{i} , … , {a}_{m} ] + … + {rate}_{t} \cdot [ {a}_{1} , … , {a}_{i} , … , {a}_{m} ] + … + {rate}_{x} \cdot [ {a}_{1} , … , {a}_{i} , … , {a}_{m} ] \qquad ( 8 )$$

$${a}_{i} = {[ 0 , {e}_{i 1} , … , {e}_{ij} , … , {e}_{i n} ]}^{T} \qquad ( 9 )$$

$${e}_{ij} = \{ \begin{matrix}1 , & i mod {2}^{j} = 1 \\ - 1 , & otherwise\end{matrix} \qquad ( 10 )$$

where rateₜ is the scale of the i^{th} action space, aᵢ is the correction phase. In this embodiment, x is the number of mixed action space scales which is set to 2, rate₁ equals 0.5, rate₂ equals 0.25, m equals 64, n equals 6 and mod is the modulo operator.

The above settings allow the Q-network to output different scales of correction actions during training and application, with larger actions quickly boosting the output of the coherent combination to a higher power at the beginning of the correction, while smaller actions are responsible for correcting the output of the system to a more desirable high output value at the end of the correction, which allows the network to complete the correction of the random phase in the minimum steps.

Additionally, in step (S4-2), reward is expressed as follows:

$$Reward = α ( PIB - {PIB}_{old} ) - β ( 0.95 - PIB ) + r \qquad ( 11 )$$

$$r = \{ \begin{matrix}1 & if PIB \geq 0.95 \\ 0 & if PIB < 0.95\end{matrix} \qquad ( 12 )$$

where α and β are adjustable parameters, in this embodiment, α equals 1, β equals 8, PIB is the normalized power in the bucket at the current moment, and PIB_{old} is the normalized power in the bucket at the previous moment.

Additionally, in step (S4-4), the coherent combination evaluation function uses the normalized power in the bucket with the following expression:

$$PIB = \frac{\int {\int }_{Ω} I ( x , y ) dxdy}{{PIB}_{max} \cdot \int {\int }_{R} I ( x , y ) dxdy} , ( \{ Ω \vert r \leq \frac{1.22 λ}{2 D} \} , \{ R \vert r > 0 \} ) \qquad ( 13 )$$

where I(x,y) is the light intensity at (x,y), λ is the wavelength of the laser, which is 1064 nm in this embodiment, and D is the diameter of the outer circle of the near-field beam, which is set to 0.28 m in this embodiment.

Additionally, in steps (S4-4), the loss function of Q-network and the weights and bias parameters of the nerves are updated with the equation:

$${y}_{t} = {r}_{t} + γ {Q}_{π} ( {s}_{t + 1} , {a}_{t + 1} ) \qquad ( 14 )$$

$${{w}_{t + 1} = {w}_{t} - α \cdot \frac{\partial Loss ( {Q}_{π} ( {s}_{t} , {a}_{t} ) , {y}_{t}}{\partial w} \vert}_{w = {w}_{t}} \qquad ( 15 )$$

where rₜ is the reward obtained at the current moment, γ is the discount factor, Q_{π}(sₜ, aₜ) is the output value of the state and action under moment t of the Q network, Q_{π}(sₜ₊₁, aₜ₊₁) is the output value of the state and action under moment t+1 of the Q network, wₜ is the weight and bias parameter of the neuron under moment t of the neural network, and wₜ₊₁ is the weight and bias parameter of the neuron under moment t+1 of the neural network; Loss( ) is L2 paradigm in this embodiment, and α is the learning rate which set to 0.01.

Referring to FIG. 4, with the setup described above, when the trained Q network acts on beams with random phases, the method can efficiently increase the normalized power in the bucket to a high value in a very short time step due to the fact that the network's computational effort is very small and the method is able to maintain a high power in every time step with the addition of random noise.

The above is a preferred embodiment of the present invention, but the embodiment of the present invention is not limited by the above, and any other changes, modifications, substitutions, combinations, and simplifications made without departing from the spirit and principle of the present invention shall be equivalent to the substitution, and are included in the scope of protection of the present invention.

What is claimed is:

1. An intelligent phase control method for laser coherent combination, characterized in that it comprises the following steps:
(S1). dividing the output of the infrared laser into M beams using a beam splitter after passing through the optical fiber, then feeding into the corresponding phase modulators to control the phases;
(S2). expanding and collimating the beams after phase modulation of the M beams, and outputting to the focusing lens to focus the M beams;
(S3). passing the focused beam through the polarizer, the microscope objective lens and the semi-transparent and semi-reflective mirror, and transmitting a part of the light to the photodetector CCD to obtain the diffracted image A after the coherent synthesis of the M-beam laser, and reflecting another part of the light to the target to obtain the light intensity value;
(S4). modulating phases by feeding a set of known voltages as the phase control signals to the phase modulators, and then obtaining a phase modulated diffracted image B after passing through the optical system, followed by resetting of the controller; superimposing the diffracted image A and the diffracted image B in the channel dimension and then inputting to the trained Q network, which outputs the Q values corresponding to each action in the action space, taking the action corresponding to the maximum Q value, and outputting phase control signals corresponding to the action to the phase modulator to correct the phase of each laser, so as to realize the output of laser coherent combination with high power.

2. The intelligent phase control method for laser coherent combination according to claim 1, characterized in that in step (S4), the phase modulation is realized by controlling the phase modulator through the FPGA; the specific implementation is realized by writing a program in the control chip FPGA, so that when it receives an action signal, it first joins the known modulation signals together with the input action signal to the phase modulator, and the CCD collects the intensity map of the coherent combination system after modulation. After the CCD collects the intensity map of the coherent combination system after modulation; FPGA reset, only the action signal being the input of the phase modulator, the CCD gets another intensity map of the coherent combination system, and the control chip stacks the two intensity maps as a state input to the network; wait for the next action input, and repeat the process.

3. The intelligent phase control method for laser coherent combination according to claim 1, characterized in that in step (S4), the acquisition of the trained Q network comprises the following steps:
(S4-1). building a convolutional neural network Q network whose input is two images stacked in channel dimension and output is a set of Q values corresponding to the action space;
(S4-2). passing M beams through the optical system to obtain a diffraction image, and then feeding a set of known phase to the controller for phase modulation, after passing through the optical system obtaining a modulated diffraction image, resetting the phase modulators; acquiring 2 diffraction image stacked as a state input, and inputting to the Q network, outputting the Q values corresponding to each action in the action space by the network, taking the action corresponding to the maximum Q value, converting the correction action into a phase correction signal and then feeding it back to the phase modulators in the optical system, obtaining a new diffraction pattern, and obtaining the intensity from PD and then performing a computation as a reward obtained from the execution of the action by the Q network;
(S4-3). back-propagating the gradient value of the loss function according to the reward to update the weights and bias parameters of the neural network, outputting again the Q values corresponding to each action in the action space, taking the action corresponding to the maximum Q value, and feeding back to the phase modulators after converting this correction action into a phase correction signal;
(S4-4). randomly generating the phase of M beams when the value of the coherent combination evaluation function is greater than a preset value, repeating steps (S4-2), (S4-3), and (S4-4), updating the neural network parameters several times, and stopping the updating when the Q network training converges.

4. The intelligent phase control method for laser coherent combination according to claim 3, characterized in that in step (S4-1), the Q network is constructed from a convolutional layer with a convolutional kernel size of 3*3, a maximal pooling layer, an activation function, and a fully-connected layer; firstly, the two stacked diffraction images are taken as the inputs, and then after three times of a convolutional layer with a convolutional kernel size of 3*3, a maximal pooling layer, and an activation function in sequence, the Q value corresponding to the action space is outputted after inputting it into the 2—layer fully-connected layer.

5. The intelligent phase control method for laser coherent combination according to claim 3, characterized in that in step (S4-1), said action space is Aₘᵢₙ, with the specific expression:
$${A}_{mn} = {rate}_{1} \cdot [ {a}_{1} , … , {a}_{i} , … , {a}_{m} ] + … + {rate}_{t} \cdot [ {a}_{1} , … , {a}_{i} , … , {a}_{m} ] + … + {rate}_{x} \cdot [ {a}_{1} , … , {a}_{i} , … , {a}_{m} ] \qquad ( 1 )$$
$${a}_{i} = {[ 0 , {e}_{i 1} , … , {e}_{ij} , … , {e}_{i n} ]}^{T} \qquad ( 2 )$$
$${e}_{ij} = \{ \begin{matrix}1 , & i mod {2}^{j} = 1 \\ - 1 , & otherwise\end{matrix} \qquad ( 3 )$$
where rateₜ is the scale of the i^{th} action space, aᵢ is the correction phase, x is the number of mixed action space scales, m equals 2^{M-1}, n equals M−1, M is the number of beams and mod is the modulo operator.

6. The intelligent phase control method for laser coherent combination according to claim 3, characterized in that in step (S4-2), reward is expressed as follows:
$$Reward = α ( PIB - {PIB}_{old} ) - β ( 0.95 - PIB ) + r \qquad ( 4 )$$
$$r = \{ \begin{matrix}1 & if PIB \geq 0.95 \\ 0 & if PIB < 0.95\end{matrix} \qquad ( 5 )$$
where α and β are adjustable parameters, PIB is the normalized power in the bucket at the current moment, and PIB_{old} is the normalized power in the bucket at the previous moment.

7. The intelligent phase control method for laser coherent combination according to claim 3, characterized in that in steps (S4-4), said coherent combination evaluation function includes, but is not limited to, the power in the bucket, the highest output power, the main flap power, the quality factor of the synthesized beam, and a combination of the above physical quantities.

8. The intelligent phase control method for laser coherent combination according to claim 3, characterized in that in steps (S4-4), the loss function of Q-network and the weights and bias parameters of the nerves are updated with the equation:
$${y}_{t} = {r}_{t} + γ {Q}_{π} ( {s}_{t + 1} , {a}_{t + 1} ) \qquad ( 6 )$$
$${{w}_{t + 1} = {w}_{t} - α \cdot \frac{\partial Loss ( {Q}_{π} ( {s}_{t} , {a}_{t} ) , {y}_{t}}{\partial w} \vert}_{w = {w}_{t}} \qquad ( 7 )$$
where rₜ is the reward obtained at the current moment, γ is the discount factor, Q_{π}(sₜ, aₜ) is the output value of the state and action under moment t of the Q network, Q_{π}(sₜ₊₁, aₜ₊₁) is the output value of the state and action under moment t+1 of the Q network, wₜ is the weight and bias parameter of the neuron under moment t of the neural network, and wₜ₊₁ is the weight and bias parameter of the neuron under moment t+1 of the neural network; Loss(is a function to measure the difference between two values, and α is the learning rate.
